(19) United States
(12) Patent Application Publication
(10) Pub. No.: US 2015/0160770 A1
(43) Pub. Date: Jun. 11, 2015

(54) CONTACT SIGNATURE CONTROL OF DEVICE

(71) Applicant: Lenovo (Singapore) Pte. Ltd., Singapore (SG)

(72) Inventors: Aaron Michael Stewart, Raleigh, NC (US); Jeffrey E. Skinner, Raleigh, NC (US); Lance Warren Cassidy, Raleigh, NC (US)

(73) Assignee: LENOVO (SINGAPORE) PTE. LTD., Singapore (SG)

(21) Appl. No.: 14/098,160

(22) Filed: Dec. 5, 2013

(51) Int. Cl. G06F 3/041

(52) U.S. Cl. CPC G06F 3/0414; G06F 2203/04105

(57) ABSTRACT

A method includes receiving sensed information corresponding to objects touching portions of a device having pressure sensors, generating a contact signature from the sensed information, selecting a control action corresponding to the contact signature, and controlling the device in accordance with the control action.

### BACKGROUND

Controlling small smart devices (e.g. smartphone) often involves the user utilizing mechanical buttons on the sides of the device or a touchscreen. Typically, this interaction requires the user to uniquely position the hand in order to reach the respective buttons and touchscreen or drives use of the other hand. In practice, the design of small or handheld smart devices rarely allows easy one-hand control of the device with a natural hand grip.

Handheld devices like tablets and smartphones have many sensors such as capacitive touch sensors over the display, accelerometers, ambient light sensors and others. Data from these sensors are often combined to extrapolate current usage mode of the device and orientation of the device. However, no solution is directly determining the nature of any force or pressure exerted upon the various surfaces of the device by the user or an inanimate object (e.g. a table). This is a lost opportunity to more accurately extrapolate intended usage and better predict when function should be adjusted.

### SUMMARY

A method includes receiving sensed information corresponding to objects touching portions of a device having pressure sensors, generating a contact signature from the sensed information, selecting a control action corresponding to the contact signature, and controlling the device in accordance with the control action.

A machine readable storage device having instructions for execution by a processor of the machine to perform receiving sensed information corresponding to objects touching portions of a device having pressure sensors, generating a contact signature from the sensed information, selecting a control action corresponding to the contact signature, and controlling the device in accordance with the control action.

A device includes a processor, a sensor positioned about the device to detect objects touching the case, and a memory device coupled to the processor, the memory device having a program stored thereon for execution by the processor to receive sensed information corresponding to objects touching portions of a device having the sensor, generate a contact signature from the sensed information, select a control action corresponding to the contact signature, and control the device in accordance with the control action.

### BRIEF DESCRIPTION OF THE DRAWINGS

FIG. 1 is a perspective view of a hand held device having multiple sensors according to an example embodiment.

FIG. 2 is a representation of a hand held device being held by a user according to an example embodiment.

FIG. 3 is a representation of a hand held device being held in an alternative manner according to an example embodiment.

FIG. 4 is a representation of a hand held device being placed on a flat surface to control the device according to an example embodiment.

FIGS. 5A and 5B are representations of a hand held device being held in a further alternative manner according to an example embodiment.

FIG. 6 is a flowchart illustrating a method of controlling a device based on a contact signature derived from a hand held device according to an example embodiment.

FIG. 7 is a block diagram of computer system used to implement methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of hardware based storage devices, either local or networked. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The article “a” or “an” means “one or more” unless explicitly limited to a single one.

Contact mechanics are leveraged to improve functionality of smart devices. More specifically, users may control small smart devices (e.g. smartphone) with natural hand grip thereby avoid the need for discrete, physical buttons. Additionally, specific information of how the phone is physically supported may be used to better extrapolate when functions should dynamically adjust.

Pressure sensing circuits (e.g. resistive and capacitive sensors), piezoelectric materials or other pressure-sensing solutions may be embedded in or layered on top of the housing material for a handheld device like a smartphone, smart watch or other device. The sensing technology is positioned within the housing such that all sides of the device (possibly, but necessarily including the display side) have pressing sensing capability to indicate the contact mechanics applied to the device. As a result, this sensing capability can detect fully where the user's fingers and hand are gripping the device. In addition, the sensors detect the level of pressure applied to the respective sides of the device and are thereby useful for determining if/how the phone is contacted by any supporting surface that exhibits a specific contact mechanic signature (e.g. resting flat on a table top).

In addition, the sensors on edge sides of the device may be sufficiently dense enough to detect finger print ridges of the user and used to authenticate the user of the device.

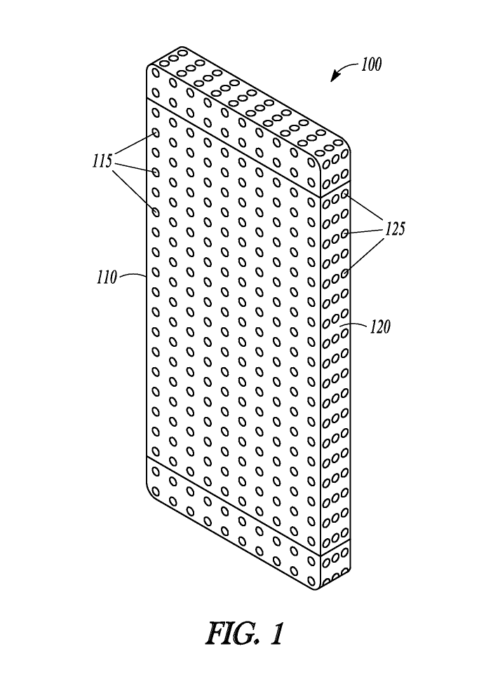

FIG. 1 is a perspective representation of a hand held device 100 having pressure sensing capability on left and right sides, and rear a housing 110. An array of sensors 115 are represented as dots covering the housing of the hand held device. In one embodiment, the housing 110 is the case of the hand held device supporting interior electronics, buttons, and touch screen on a front side of the device 100 not visible in FIG. 1. In further embodiments, the housing may take the form of an external case that is shaped to hold the device 100 and connect via one or more electrical connectors.

A side 120 of the housing 110 corresponds to an edge of the housing 110, and may have a very high density of sensors 125 embedded, layers on top of, or otherwise disposed on the side 120. Sensors 125 may also be similarly disposed on other sides of the housing 110. The density of sensors 125 in one embodiment may be sufficient to facilitate detection of ridges of skin on fingers corresponding to finger prints, which can server as a biometric verification of a user. The sensors 115 and 125 may have pressing sensing capability to indicate contact mechanics applied to the device 100. As a result, this sensing capability can detect fully where a user's fingers and hand are gripping the device and how hard the grip is.

Sensed information corresponding to how the user is gripping the device or what contact signature is presently applied to the device may be used to control functioning of the device. In one example, when a user grabs the device 100 and squeezes it, the device may turn on and authenticate the user utilizing one or both of a grip contact signature and detected fingerprints or partial fingerprints.

There are several additional usage scenarios with smart devices in which sensed information provides a context that leads to short list of possible actions that are likely to match an intent of the user. In these situations, having to push a discrete button or manipulate a specific on-screen control can require significant accuracy or dexterity. In this type of context, an action by the user, such as gripping or squeezing the device can be detected, translated into a contact signature, and can be used to control the device. One such control is to cause performance of the most likely action given a mode that the device is in. Another control could be to avoid an inadvertent activation of one or more actions. A specific contact signature (matching the users grip pattern) may be needed to cause the action to occur.

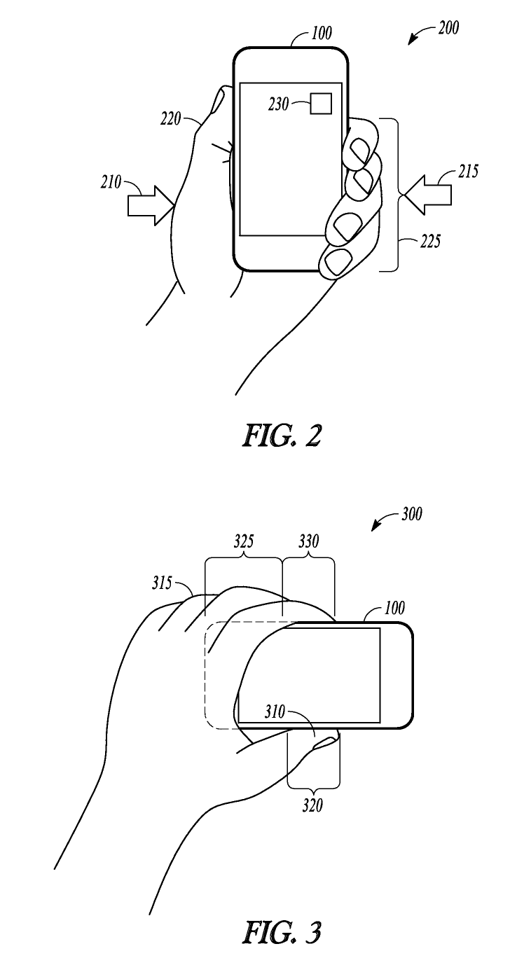

One natural grip of the device 100 as illustrated in FIG. 2 at 200 can be sensed by the sensors 115 and 125 to detect that the user is holding the device in a natural manner. There may be other different grips that are natural to different users, and the term natural grip is meant to not be limited to the particular grip shown. For instance, a further natural grip utilizes the little finger on a bottom edge of the device, supporting it with only three fingers on the side at 225. A still further natural grip may occur when the user is extending their thumb across the screen of the device to provide user input. In that natural grip, the side edge proximate the thumb is actually pressing more against a palm portion of the thumb. Each grip may be translated into a specific contact signature and utilizes to control actions or modes of the device 100.

In one example, a squeeze indicated by arrows 210 and 215 and effectuated by applying pressure with a part of the hand including the thumb 220 on one side edge of the device 100 and one or more fingers 225 on an opposite side edge may be sensed and used to control device 100 operation without the user having to locate and press buttons or utilize specific on-screen controls. The detection of a squeeze may be added to the contact signature, or changes in pressure may simply be compared to thresholds to determine that a squeeze has been effected by the user. The thresholds may be set by a manufacturer, vendor, or user in various embodiments in a manner similar to using a pointer sensitivity slide bar.

The operations or functions that may be selected by the squeeze may depend on the context of the device, and the squeeze may be referred to as a contextual squeeze or squeezes. One context may be a device operating as a phone and receiving an incoming call. The squeeze may be used to silence an alert regarding the call. Such a control may be referred to as a context relevant action. The squeeze may alternatively be used to accept the call.

A further context may be a device that is in a locked mode. The grip may be detected, and a squeeze may unlock the phone. If in an on state in one or more contexts, the squeeze may cause the phone to lock. If in a camera mode, a squeeze may be used to cause a picture to be taken. If viewing screens generated by an app that is providing data to a user via the screen of the device, squeezing may cause a refresh of information being displayed. In some cases, a double squeeze may be utilized to cause different controls to occur regardless of context, or based on context. For instance, a double squeeze may consist of two successive squeezes of a specified duration and separation in time, and may cause the device to lock and enter an energy conservation mode. As above, such squeezes may need to be associated with a certain grip of the phone in order to cause the action.

In further embodiments, grip data may be combined with other sensor 230 data, such as accelerometer data, gyroscope, magnometer data etc., to enable a specific mode of the device and/or momentarily adjust the meaning of a natural squeeze control. One example of using such sensor data involves automatically controlling the device 100 to enter into a camera mode when a natural grip is detected as shown at 300 in FIG. 3. A typical user grip is shown with a thumb 310 on one side of the device and fingers 315 on top of the device. Profiles of detected grip are show at 320 for thumb 310 and at 325 and 330 for fingers 315. When this grip, or any other type of grip associated with the user taking pictures with the device 100 are detected, the device may enter a camera mode. The mode may also be entered when accelerometer sensor 230 data indicates that the device is being held vertically. In some embodiments, both the grip and orientation of the device may be used to enter camera mode. Once in the camera mode, a squeeze of the grip may be used to cause the device to take a picture. If a video mode is most preferred by a user when using the camera, the squeeze may be used to record or stop recording.

In further embodiments, a gyroscope and magnometer may be used for more absolute positioning. In one example embodiment the device remains in a user's pocket and a squeeze may be used to dismiss an incoming call. In this situation, the device is reacts in a context sensitive manner based on the state of a service on the phone (incoming call) and data from an ambient light sensor (dark) that governs the meaning of the squeeze. In still further embodiments, the context may include location (GPS) and time of day. Other specific contact signatures may be used to adjust or control many different functions based on contact signature and context.

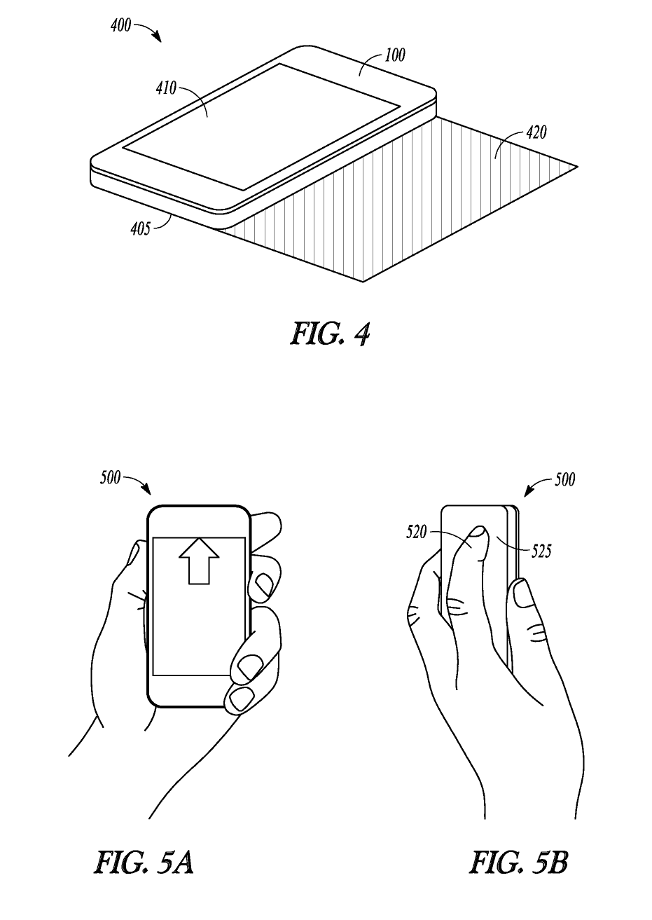

An example of such a signature as shown in FIG. 4 at 400 includes a resting contact mechanic signature. A full contact mechanic signature on a specific surface of the device 100, such as the back side 405 opposite a display side 410, can help predict if the device is resting on a surface 420. In this state, the function of the device 100 might be controlled or adjusted to enable a hands-free mode, accommodate increased distance between user and device, or momentarily adjust enable/disable (or adjust hierarchy) of available input methods.

With touch-screen sensing, it is impossible to comfortably manipulate on-screen content while using only one hand. Pressing sensing that enable detection of contact mechanic signatures may also be used for general user input such as scrolling content and selecting items via tapping a finger as shown in FIGS. 5A and 5B at 500. The benefit is the user can manipulate content 510 visible on a display side 515 as illustrated in FIG. 5A without bringing another hand/finger in front of the display 515, which tends to momentarily block the user's view to on-screen content. As shown in FIG. 5B, a finger 520 may be moved on a back side 525 of the device 100 and such motions detected and used to select or scroll the content being displayed. Such motions may be translated to effect controls using the same movements a user would make on the front display, including gestures and tapping. In further embodiments, the motions may not translate the same as motions on the front of the device. For instance, with a natural grip, it may be easier to swipe an index finger laterally between side edges. That motion may be translated to cause scrolling of text transverse to the motion. The detected grip may be used to change the mode of gesture translation to make control of the display easier for a user using the detected grip.

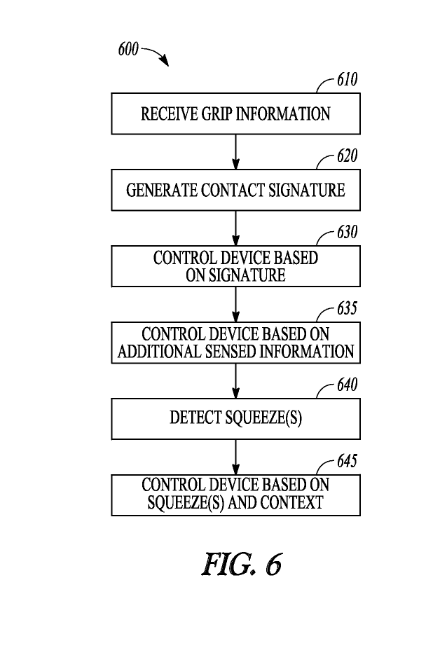

FIG. 6 is a flowchart illustrating a method 600 of controlling a device utilizing detected grip. At 610, a processor receives grip information from the sensors on the device. The processor then generates a digital representation of the grip and compares it to known grips at 620 to identify the specific grip being used to hold the device. At 630, the specific grip is used to select an action or change a mode of the device. Optionally, at 635, additional sensor data, such as accelerometer data is also used to select an action or change a mode of the device. At 640, one or more squeezes of the device is detected and provided to the processor. The processor then uses the data representative of the squeeze or squeezes, and optionally the context of the device, to select an action or change a mode at 645. Such actions or changes in mode may be stored in one or more tables used by the processor to determine the action or change in mode. The tables may include a hierarchy of tables such that the actions or changes in mode may be dependent on current modes and previous mode changes that have occurred.

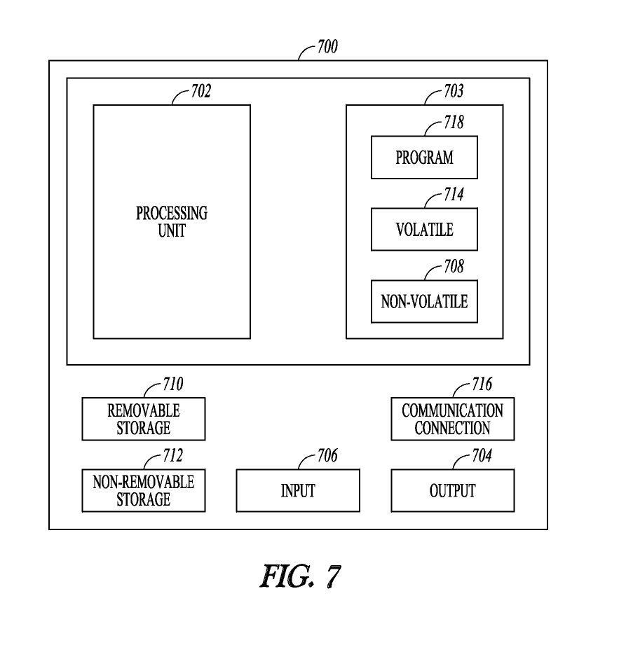

FIG. 7 is a block schematic diagram of a computer system 700 to implement device 100 and other computing resources according to example embodiments. All components need not be used in various embodiments. One example computing device in the form of a computer 700, may include a processing unit 702, memory 703, removable storage 710, and non-removable storage 712. Sensors 115 and 125 may be coupled to provide data to the processing unit 702. Memory 703 may include volatile memory 714 and non-volatile memory 708. Computer 700 may include—or have access to a computing environment that includes—a variety of computer-readable media, such as volatile memory 714 and non-volatile memory 708, removable storage 710 and non-removable storage 712. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 700 may include or have access to a computing environment that includes input 706, output 704, and a communication connection 716. Output 704 may include a display device, such as a touchscreen, that also may serve as an input device. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 702 of the computer 700. A hard drive, CD-ROM, and RAM are some examples of articles including a non-transitory computer-readable medium. For example, a computer program 718 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 700 to provide generic access controls in a COM based computer network system having multiple users and servers.

### Examples

1. A method comprising:

receiving sensed information corresponding to objects touching portions of a a device having pressure sensors;

generating a contact signature from the sensed information;

selecting a control action corresponding to the contact signature; and

controlling the device in accordance with the control action.

2. The method of example 1 wherein the sensed information comprises sensed pressure detected by an array of pressure sensors.

3. The method of any of examples 1-2 wherein the contact signature includes contact point locations of a hand and fingers on the device.

4. The method of any of examples 1-3 and further comprising:

detecting when the device has been squeezed by a user contacting the device;

selecting a control action corresponding to the detected squeeze; and

controlling the device in accordance with the control action.

5. The method of example 4 wherein the control action comprises a mode change.

6. The method of any of examples 4-5 wherein the control action comprises a function to be performed by the device.

7. The method of example 6 wherein the contact signature is used to select a camera mode and wherein a squeeze is used to cause the device to take a picture when in the camera mode.

8. The method of any of examples 1-7 and further comprising:

receiving additional sensed information not associated with a contact signature of the device; and

using the received additional sensed information to control the device.

9. The method of example 8 wherein the additional sensed information comprises accelerometer information, gyroscope information, and magnometer information.

10. The method of any of examples 1-9 wherein the contact signature is representative of a device being placed on a flat surface, and a corresponding action places the device in a speaker phone mode during a call.

11. A machine readable storage device having instructions for execution by a processor of the machine to perform:

receiving sensed information corresponding to objects touching portions of a a device having pressure sensors;

generating a contact signature from the sensed information;

selecting a control action corresponding to the contact signature; and

controlling the device in accordance with the control action.

12. The computer readable storage device of example 11 wherein the sensed information comprises sensed pressure detected by an array of pressure sensors on the device.

13. The computer readable storage device of any of examples 11-12 wherein the contact signature includes contact point locations of a hand and fingers on the device and further comprising:

detecting when the device has been squeezed by a user contacting the device;

selecting a control action corresponding to the detected squeeze; and

controlling the device in accordance with the control action.

14. The computer readable storage device of example 13 wherein the control action comprises a mode change or a function to be performed by the device.

15. The computer readable storage device of any of examples 11-14 and further comprising:

receiving additional sensed information not associated with a contact signature of the device; and

using the received additional sensed information to control the device.

16. A device comprising:

a processor;

a sensor positioned about the device to detect objects touching the case; and

a memory device coupled to the processor, the memory device having a program stored thereon for execution by the processor to:

receive sensed information corresponding to objects touching portions of a device via the sensor;

generate a contact signature from the sensed information;

select a control action corresponding to the contact signature; and

control the device in accordance with the control action.

17. The device of example 16 wherein the sensors comprises an array of pressure sensors, and the sensed information comprises sensed pressure detected on the device.

18. The device of any of examples 16-17 wherein the contact signature includes contact point locations of a hand and fingers on the device and wherein the program further causes the processor to:

detect when the device has been squeezed by a user contacting the device;

select a control action corresponding to the detected squeeze; and

control the device in accordance with the control action.

19. The device of example 18 wherein the control action comprises a mode change or a function to be performed by the device.

20. The device of any of examples 16-19 wherein the program further causes the processor to:

receive additional sensed information not associated with a contact signature of the device; and

use the received additional sensed information to control the device.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
receiving sensed information corresponding to objects touching portions of a a device having pressure sensors;
generating a contact signature from the sensed information;
selecting a control action corresponding to the contact signature; and
controlling the device in accordance with the control action.

2. The method of claim 1 wherein the sensed information comprises sensed pressure detected by an array of pressure sensors.

3. The method of claim 1 wherein the contact signature includes contact point locations of a hand and fingers on the device.

4. The method of claim 1 and further comprising:
detecting when the device has been squeezed by a user contacting the device;
selecting a control action corresponding to the detected squeeze; and
controlling the device in accordance with the control action.

5. The method of claim 4 wherein the control action comprises a mode change.

6. The method of claim 4 wherein the control action comprises a function to be performed by the device.

7. The method of claim 6 wherein the contact signature is used to select a camera mode and wherein a squeeze is used to cause the device to take a picture when in the camera mode.

8. The method of claim 1 and further comprising:
receiving additional sensed information not associated with a contact signature of the device; and
using the received additional sensed information to control the device.

9. The method of claim 8 wherein the additional sensed information comprises accelerometer information, gyroscope information, and magnometer information.

10. The method of claim 1 wherein the contact signature is representative of a device being placed on a flat surface, and a corresponding action places the device in a speaker phone mode during a call.

11. A machine readable storage device having instructions for execution by a processor of the machine to perform:
receiving sensed information corresponding to objects touching portions of a device having pressure sensors;
generating a contact signature from the sensed information;
selecting a control action corresponding to the contact signature; and
controlling the device in accordance with the control action.

12. The computer readable storage device of claim 11 wherein the sensed information comprises sensed pressure detected by an array of pressure sensors on the device.

13. The computer readable storage device of claim 11 wherein the contact signature includes contact point locations of a hand and fingers on the device and further comprising:
detecting when the device has been squeezed by a user contacting the device;
selecting a control action corresponding to the detected squeeze; and
controlling the device in accordance with the control action.

14. The computer readable storage device of claim 13 wherein the control action comprises a mode change or a function to be performed by the device.

15. The computer readable storage device of claim 11 and further comprising:
receiving additional sensed information not associated with a contact signature of the device; and
using the received additional sensed information to control the device.

16. A device comprising:
a processor;
a sensor positioned about the device to detect objects touching the case; and
a memory device coupled to the processor, the memory device having a program stored thereon for execution by the processor to:
receive sensed information corresponding to objects touching portions of a device via the sensor;
generate a contact signature from the sensed information;
select a control action corresponding to the contact signature; and
control the device in accordance with the control action.

17. The device of claim 16 wherein the sensor comprises an array of pressure sensors, and the sensed information comprises sensed pressure on the device.

18. The device of claim 16 wherein the contact signature includes contact point locations of a hand and fingers on the device and wherein the program further causes the processor to:
detect when the device has been squeezed by a user contacting the device;
select a control action corresponding to the detected squeeze; and
control the device in accordance with the control action.

19. The device of claim 18 wherein the control action comprises a mode change or a function to be performed by the device.

20. The device of claim 16 wherein the program further causes the processor to:
receive additional sensed information not associated with a contact signature of the device; and
use the received additional sensed information to control the device.
